(19) United States
(12) Patent Application Publication
(10) Pub. No.: US 2018/0285808 A1
(43) Pub. Date: Oct. 4, 2018

(54) USING PROXIMITY SENSORS FOR BIN ASSOCIATION AND DETECTION

(71) Applicant: Amazon Technologies, Inc., Seattle, WA (US)

(72) Inventors: Waldemar Bogdan Swiercz, Malden, MA (US); Jeremiah David Brazeau, Hudson, NH (US)

(21) Appl. No.: 15/478,106

(22) Filed: Apr. 3, 2017

(51) Int. Cl. G06Q 10/08; G06K 19/07

(52) U.S. Cl. CPC G06Q 10/087; G06K 19/0723

(57) ABSTRACT

Embodiments are directed to an inventory system that comprises sensors coupled with an inventory holder and a management module to automatically determine a location of an interaction with an inventory bin of the inventory holder by an inventory item without requiring hand-scanners. The system may determine the location of the interaction with which to associate to a particular bin of the inventory holder based on signal information provided by one or more proximity sensors coupled with the inventory bins of the inventory holder. The system may update information to associate the inventory item with the location of the particular bin in the inventory holder in response to determining the location of the interaction using the signal information.

### BACKGROUND

Modern inventory systems, such as those in mail order warehouses, supply chain distribution centers, airport luggage systems, and custom-order manufacturing facilities, face significant challenges in responding to requests for inventory items. As inventory systems grow, the challenges of simultaneously completing a large number of packing, storing, and other inventory-related tasks become non-trivial. In inventory systems tasked with responding to large numbers of diverse inventory requests, inefficient utilization of system resources, including space, equipment, and manpower, may result in lower throughput, unacceptably long response times, an ever-increasing backlog of unfinished tasks, and, in general, poor system performance.

In an example, an inventory system may include storage spaces for stowing or picking items. The distribution of the items in the storage area are tracked to enable different inventory-related actions. As the inventory system, amount of inventory, and consumer demand grows, so too does the time and cost required to accurately track the items and accurately detect inventory-related actions thereby reducing the inventory system efficiency and throughput. Additionally, expanding or reducing the size or capabilities of many inventory systems requires significant changes to existing infrastructure and equipment. As a result, the cost of incremental changes to capacity or functionality may be prohibitively expensive, limiting the ability of the system to accommodate fluctuations in system throughput.

### BRIEF DESCRIPTION OF THE DRAWINGS

Various embodiments in accordance with the present disclosure will be described with reference to the drawings, in which:

FIG. 1 illustrates an example configuration of inventory bins of an associated material holder with corresponding proximity sensors utilized in an inventory bin detection feature, in accordance with at least one embodiment;

FIG. 2 illustrates an example workflow for an inventory bin detection feature, in accordance with at least one embodiment;

FIG. 3 illustrates an example configuration of inventory bins of an associated material holder with corresponding proximity sensors utilized in the inventory bin detection feature, in accordance with at least one embodiment;

FIG. 4 illustrates an example configuration of inventory bins of an associated material holder with corresponding proximity sensors utilized in the inventory bin detection feature, in accordance with at least one embodiment;

FIG. 5 illustrates components of an inventory system according to a particular embodiment;

FIG. 6 illustrates in greater detail the components of an example management module that may be utilized in particular embodiments of the inventory bin detection features for an inventory system;

FIG. 7 illustrates an example material holder that may be utilized in particular embodiments of the inventory system;

FIG. 8 illustrates an example flowchart for an inventory bin detection feature, in accordance with at least one embodiment;

FIG. 9 illustrates an example flowchart for an inventory bin detection feature, in accordance with at least one embodiment; and

FIG. 10 illustrates an environment in which various features of the inventory system may be implemented, in accordance with at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments herein are directed to an inventory management system having multiple inventory holders with one or more inventory bins for storing materials or inventory items and drive units for moving the inventory holders. Inventory holders may be an example of a material holder and may be configured to store inventory, items, inventory items, packages, material, or any suitable object for storage, transfer, or removal that may be performed in an inventory management system, warehouse, workspace, or suitable storage environment utilizing one or more corresponding inventory bins or material bins. Specifically, features herein are directed to automatically determining a location of an interaction to associate with a particular inventory bin of an inventory holder. For example, the interaction could be a result of an interaction by an inventory item or any object (e.g., a hand) with the inventory holder and/or inventory bin (i.e., had an inventory item placed by a user or entity in the inventory bin or had the inventory item removed from the inventory bin of an inventory holder). Inventory holder information or material holder information corresponding to the inventory holder may be updated to associate/disassociate an inventory item with the location of the particular inventory bin based on determining the location of the interaction as detected by one or more corresponding proximity sensors.

The inventory management system (or “inventory system,” used interchangeably) may comprise a proximity sensor (or multiple proximity sensors), a server computer or computer system that implements a management module in addition to the multiple inventory holders, inventory bins, and drive units. The proximity sensor may be coupled with, associated with, or otherwise bodily incorporated to the inventory holder and/or inventory bins of the inventory holder. The proximity sensor may be configured to provide signal information in response to detecting an interaction with the inventory holder and/or inventory bin, for example during a stow, pick, or transfer operation of an inventory item by an entity of the inventory system. In accordance with at least one embodiment, the signal information or signals provided by the proximity sensor may be interpreted by the management module to identify a location of a particular bin that is being interacted with by an entity. In embodiments, the signal information or signals provided by the proximity sensors may indicate an interaction detected by a particular proximity sensor. The proximity sensor can detect a range of proximate items (e.g., how close the item is to the sensor) and provide corresponding ranges of values for each item. For example, a single sensor may detect relative distances of items, where stronger values are recorded/provided for items that are closer to the sensor and weaker values are recorded/provided for items that are not as close to the sensor. However, each individual sensor may not be able to detect a location of the item along a line (e.g., when the proximity sensor is configured as a string or line sensor). In some examples, a set of sensors can be configured to run in either a vertical or horizontal configuration with respect to a facing of an inventory holder and may provide signal information that includes a value that indicates that an interaction has occurred with the proximity sensor(s). The signal information may be analyzed by the computer system and/or management module to identify a location of the interaction with respect to the facing (as opposed to with respect to each individual sensor). The signal information provided by the proximity sensors may be utilized to determine the location of the interaction or locate the interaction with respect to the facing of the inventory holder. For example, a pair of vertically configured proximity sensors may provide signal information indicating an interaction has occurred somewhere along the vertical sensors (e.g., to give an x-axis location estimation) and a pair of horizontally configured proximity sensors may provide signal information that indicates an interaction has occurred along the horizontal sensors (e.g., to give a y-axis location estimation). The relative strengths of each signal can help estimate which of the two (or more) sensors were closer to the sensed item. The computer system and/or management module may utilize the signal information and responding proximity sensors to determine a location of the interaction with respect to the facing of the inventory holder.

In embodiments, the proximity sensor may be configured to provide information that identifies a relative strength of the interaction (storage, removal, or transfer of an inventory item with an inventory bin of an inventory holder) with the proximity sensor. The computer system and/or management module may utilize an algorithm that determines the relative location of the interaction based on the signal information from the proximity sensor to map the location of the interaction to a particular proximal inventory bin of the inventory holder. For example, the management module may utilize the strongest signals provided by proximity sensors, locate the interaction with respect to the facing of an inventory holder, map the location of the interaction to a proximal inventory bin location, and determine that the interaction occurred at the particular inventory bin of an inventory holder. The inventory management system may maintain/access inventory holder information that describes an attribute of the inventory holder, including inventory bins stored in the inventory holder, inventory items contained in the inventory holder or inventory bins, colors, shapes, sizes of the inventory items in the inventory holder, locations of the inventory bins within the inventory holder, and locations of the one or more proximity sensors, movement (translational or rotational) of the inventory holder by a mobile drive unit, and the like. In response to determining the location of a particular inventory bin interacted with by an inventory item, the management module may update the inventory holder information to associate the location of the particular inventory bin with the inventory item.

As a sample illustration, the inventory management system may receive or obtain information related to an inventory task for an inventory item for a corresponding inventory holder. For example, the inventory management system may receive information identifying that a pair of tennis shoes are required to be stored in the inventory holder. The inventory management system may receive signal information from one or more proximity sensors of the inventory holder identifying an interaction with the inventory holder, in the present example a placement of the pair of tennis shoes by an entity in a bin of the inventory holder. The management module/inventory management system may utilize the signal information from the proximity sensors to identify a location for the interaction to map to a particular inventory bin of a plurality of inventory bins of the inventory holder that the entity placed the pair of tennis shoes. For example, the management module may identify the strongest signals provided by particular proximity sensors of the inventory holders to determine the location of the interaction and map the location of the interaction to a location for a particular inventory bin. Thereafter, the inventory holder information may be updated to associate the pair of tennis shoes with the location of the particular inventory bin for the inventory holder which may be utilized for subsequent inventory related tasks.

In accordance with at least one embodiment, a facing of an inventory holder may include one or more proximity sensors arranged in a vertical configuration with respect to each facing of the inventory holder and one or more proximity sensors arranged in a horizontal configuration with respect to each facing of the inventory holder. An interaction by an entity placing an inventory item in a given inventory bin of the inventory holder may result in a cross-section of the vertical and horizontal proximity sensors providing signal information to the management module. The management module may interpret the signal information to identify a set of the horizontal and vertical proximity sensors that provided the strongest signal, and use the relative orientation of these sensors to identify a location of the interaction and map the location of the interaction to a corresponding particular inventory bin that was interacted with. In embodiments, the signal information provided by the sensors can be utilized to identify a bin of an inventory holder which is accessed by the associate. In some embodiments, each inventory bin of an inventory holder may comprise one or more walls with corresponding proximity sensors. Upon an interaction with the inventory bin, the proximity sensors bordering the bin along the vertical and horizontal edges of the bin, and possibly the neighboring proximity sensors bordering neighboring inventory bins may provide signals or signal information to the management module for use in identifying the location of the interaction for use in mapping the location of the interaction to a particular inventory bin. For example, the management module may maintain a mapping of the proximity sensors that border each individual inventory bin, and this mapping can be utilized to determine which bin has been interacted with.

This process may be an improvement on standard scanning processes in inventory management. For example, a typical interaction between a user, inventory item, and an inventory holder may comprise a user with a hand scanner. The user may use the hand scanner to scan the inventory item that they wish to place into an inventory holder, scan the inventory holder to identify the origin of the item with the system, and scan or otherwise interact with an inventory bin that they stored the item to associate the item with the inventory bin's location for the inventory holder with the system. Traditionally, this multi-scanning process would help track the location of the items between receiving the inventory item from the provider in a shipping crate, to stowing the item in a fulfillment center, to packing and shipping the item to a consumer after the item is ordered by that consumer. Each step of the traditional process may involve scanning with the hand scanner. The improved scanning process may be implemented to remove the scanner from the user's hands and maintain a sensor that is not handled by the user. This improvement may help to, at least in part, free the user's hands for other tasks and increase the speed of the user stowing or picking inventory items to/from the inventory holder. The sensor may help detect which inventory item is stowed or picked, where the inventory item is placed or moved between inventory holders. Further, some processes in inventory management may utilize exterior sensors that can be blocked or obfuscated by an entity interacting with an inventory holder. Systems that utilize exterior sensors may also rely on exact placement of the inventory holder with respect to the exterior sensor or otherwise introduce inaccuracies in the detection of objects or locations of interactions with the inventory holder during an inventory related task. The improvements described herein increase the throughput of the inventory management system because users may be able to more efficiently, quickly, and securely move items in and out of inventory holders while the system automatically detects an interaction with the inventory holder during an inventory related task, determines a location of a particular inventory bin associated with the inventory related task, and updates inventory holder information to associate the inventory item with the particular inventory bin and location of the particular inventory bin without the need for a user to utilize a hand scanner.

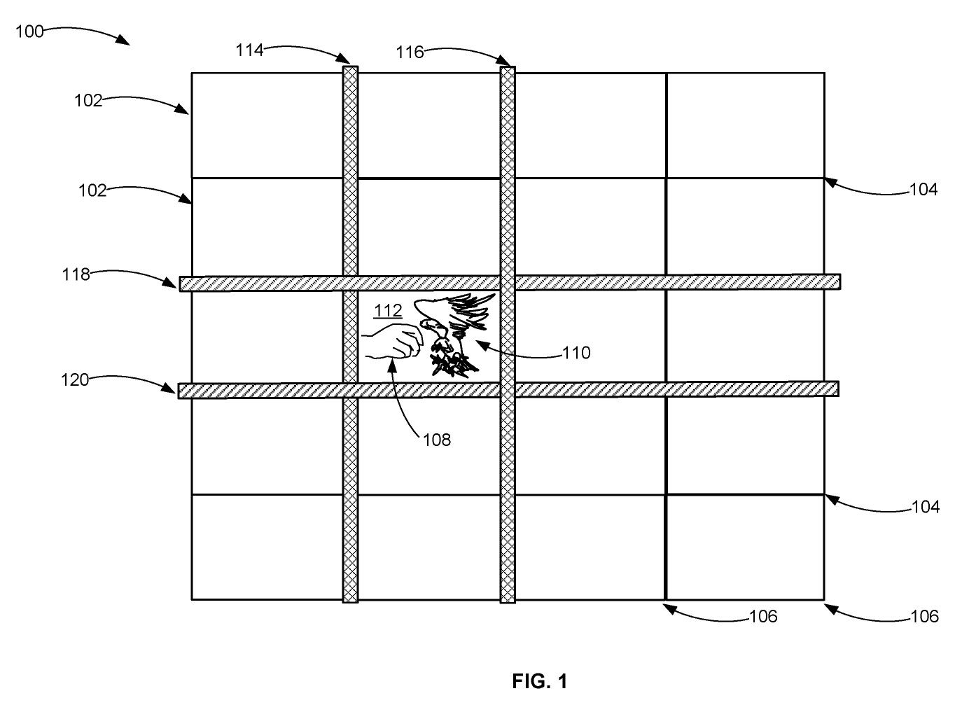

FIG. 1 illustrates an example configuration of inventory bins of an associated material holder with corresponding proximity sensors utilized in an inventory bin detection feature, in accordance with at least one embodiment. FIG. 1 illustrates an inventory holder 100 that includes one or more inventory bins 102. In accordance with at least one embodiment, a facing of the inventory holder 100 may include one or more proximity sensors where a portion of the proximity sensors 104 are arranged or configured in a horizontal fashion with respect to the facing of the inventory holder 100 and another portion of the proximity sensors 106 are arranged or configured in a vertical fashion with respect to the facing of the inventory holder 100. The proximity sensors 104 and 106 may be configured to detect or sense an interaction by a user and/or inventory item with the inventory holder 100 or inventory bins 102 during an inventory related task such as stowing, picking, or transferring of inventory items from inventory holder 100. As illustrated in FIG. 1, each proximity sensor of the proximity sensors 104 and 106 may run along a line, either vertical or horizontal with respect to the facing of the inventory holder 100, and be configured to detect an interaction by an item, object, or entity. In embodiments, the proximity sensors 104 and 106 may be bodily incorporated into each facing of the inventory holder 100, along each facing of each inventory bin 102, or otherwise incorporated or associated with the inventory holder 100 or inventory bin 102.

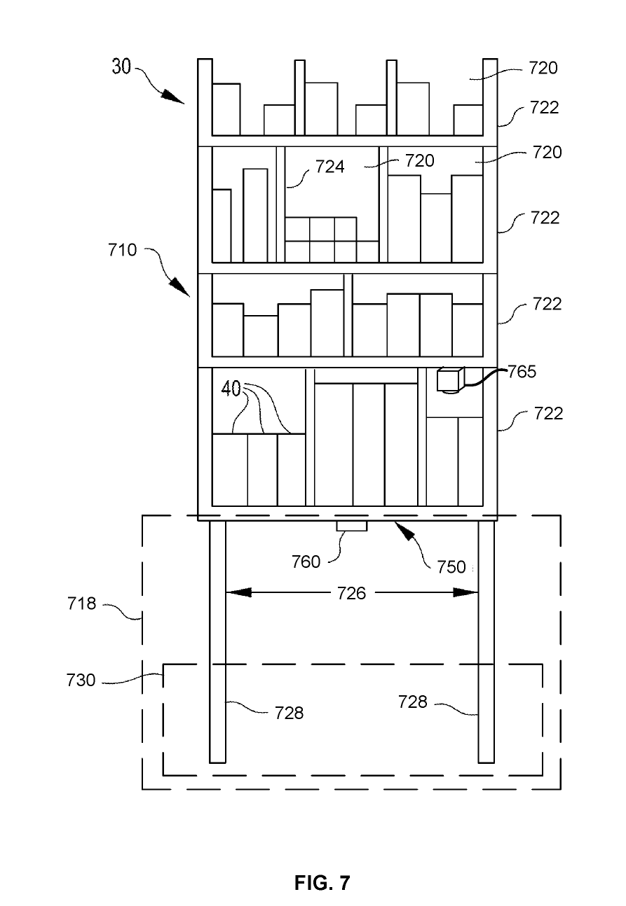

As an illustrative example, user 108 may place inventory item 110 within inventory bin 112. The placement of the inventory item 110 within the inventory bin 112 may cause proximity sensors 114, 116, 118, and 120 to detect or sense the interaction with the inventory holder 100 and/or inventory bin 112. As illustrated in FIG. 1, the vertical proximity sensors 114 and 116 (depicted as cross hatch lines in FIG. 1) and horizontal proximity sensors 118 and 120 (depicted as a singular slash lines in FIG. 7) are active or sensing the interaction in response to the placing of inventory item 110 by user 108 in inventory bin 112. In embodiments, activated proximity sensors 114-120 would obtain or record signal information regarding the interaction and transmit the signal information to a management module and/or computer system implementing the management module to determine the location of the interaction along the facing of the inventory holder 100. The signal information may include a single value that identifies a strength of the interaction detected by the responding proximity sensors 114-120. For example, proximity sensor 114 and 116 may each provide signal information that includes value that identify the strength of the interaction detected based on the placing of item 110 by user 108. Further, sensors 118 and 120 may each provide signal information that includes the strength of the interaction detected in response to the placing of item 110 by user 108 in inventory holder 100.

As described herein, the management module may utilize the signal information to determine a relative location of the placement of the inventory item 110 with respect to the inventory holder 100 by utilizing the signal information provided by sensors 714-720. With respect to FIG. 1, the management module may determine the location of the interaction along the facing of inventory holder 100 and map the location to a corresponding bin which in the case of FIG. 1 corresponds to inventory bin 112. In embodiments, the management module may maintain a mapping of locations to inventory bins, proximity sensors to inventory bins, and inventory bins with respect to the inventory holder. Once a location of an interaction has been determined a mapping or look up operation may be performed to associate the site of the interaction to an appropriate inventory bin of the inventory holder. The management module may update inventory holder information to associate the inventory item 110 with the a location of inventory bin 112 for inventory holder 100 for use in subsequent inventory related tasks or tracking of inventory item 110 within an inventory management system.

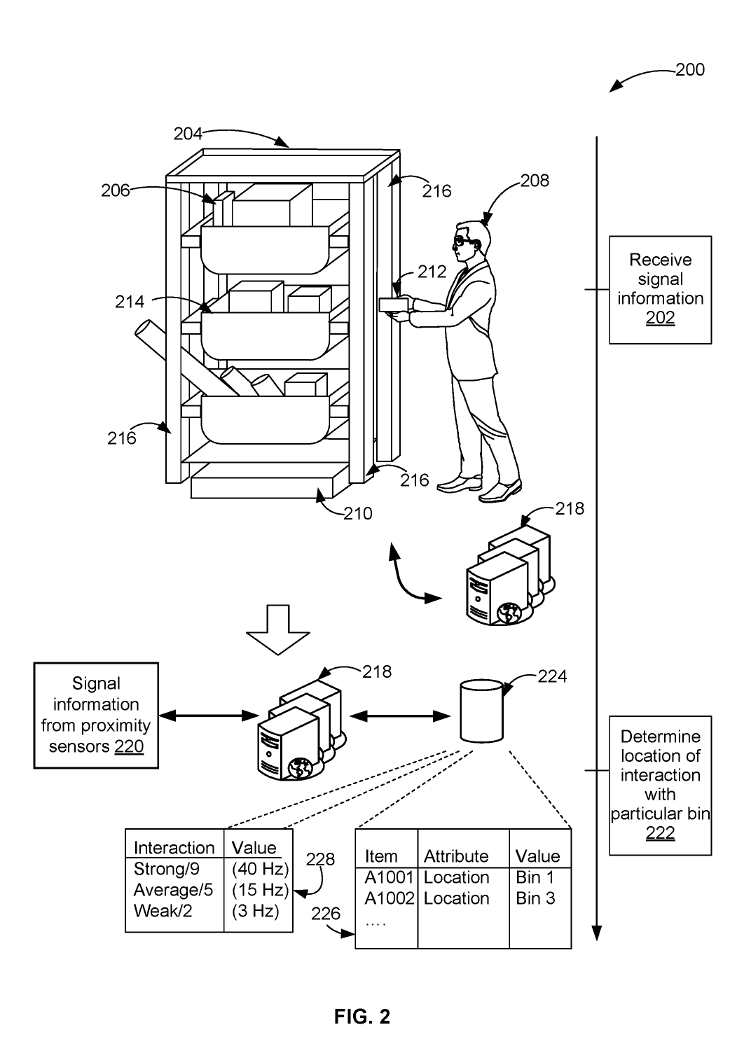

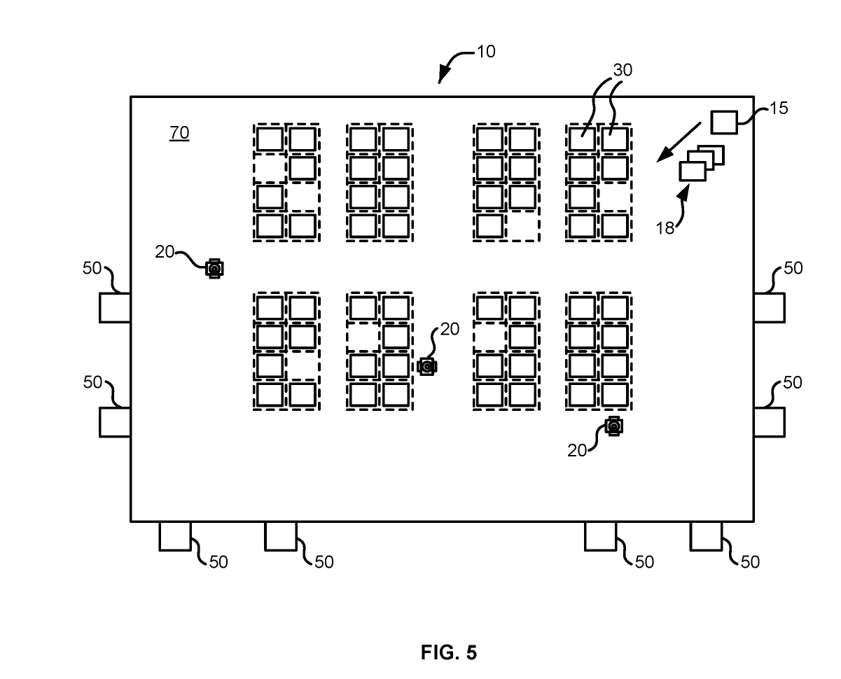

FIG. 2 illustrates an example workflow for an inventory bin detection feature, in accordance with at least one embodiment. In a non-limiting example, the workflow 200 may receive signal information from proximity sensors of an inventory holder/inventory bin at 202. For example, the inventory holder 204 may be configured to store inventory items 206 that are accessed by a user 208. A mobile drive unit 210 may be configured to move the inventory holder 204 to a location that is accessible by the user 208. Additional details about inventory holder 204, mobile drive unit 210, and system that manages these and other devices is provided at least with FIGS. 5-7.

In the workflow 200, the user 208 may store or place an inventory item 212 in an inventory bin 214 of the inventory holder 204. By placing the inventory item 212 in the inventory bin 214, the user 208 and inventory item 212 may interact with one or more proximity sensors 216 bodily incorporated or coupled with the inventory holder 204 or inventory bin 214. The one or more proximity sensors 216 may detect the placement of the inventory item 212 and provide signal information as output to the system for analysis (e.g., using a processor, management module, etc.) and determination of the location of the interaction with which to associate to a particular inventory bin interacted with by the user 208. The one or more proximity sensors 216 may provide various types of output or signal information (e.g., using electrical or optical signals, etc.,) to the system which may be utilized to determine an approximate location of the interaction by the inventory item 212 with the inventory holder 204 to identify a particular inventory bin that the inventory item 212 was placed within. For example, the one or more proximity sensors 216 may be capacitive proximity sensors that generate an electrostatic field and react to changes in capacitance caused when an object enters the electrostatic field. Corresponding oscillators for the capacitive proximity sensors may provide a range of values or strength of signals from one or more capacitive proximity sensors that have reacted to the change in capacitance caused by the user 208 storing the inventory item 212 within an inventory bin 214 of the inventory holder 204. For example, neighboring or proximal inventory bins and their corresponding capacitive proximity sensors of inventory holder 204 may provide signal information in response to the user 208 placing the inventory item 212 in inventory holder 204. In accordance with at least one embodiment, the signal information may be utilized to determine the location of interaction (i.e., placing of inventory item 212 within inventory bin 214 of inventory holder 204).

The inventory items may be contained within the inventory holders. For example, during a “stowing” process, a user may receive an inventory item from an item provider, conveyor belt, a second inventory holder, or other source and place the item into an inventory bin inside of an inventory holder. The user may place the inventory item in a location in the inventory holder that encompasses the entire inventory item so that no part of the inventory item hangs over the side of the inventory bin or inventory holder. The inventory bins may be different sizes to accommodate different sized items.

The one or more proximity sensors 216 may generate signal information, signals, or data points for each object or interaction they detect with the inventory holder 204 or associated inventory bins such as inventory bin 214. The one or more proximity sensors 216 may transmit the signal information, signals, or data to a server computer or computer system 218 that implements the management module and is associated with the inventory management system. The computer system 218 and implemented management module may analyze the signal information to determine the location of the interaction by the inventory item 212 and/or user 208 with the inventory holder 204. In embodiments, computer system 218 and the management module may be associated with the mobile drive unit 210, the inventory holder 204 itself, or be a separate entity that is in communication with the mobile drive unit 210 and/or inventory holder 204 via available networks such as a server computer in communication with the inventory holder 204 and/or mobile drive unit 210.

The determination of the location of interaction with the inventory holder 204 (storing of inventory item 212) may be based in part on the signal information obtained by the one or more proximity sensors 216. For example, the signal information from the one or more proximity sensors 220 may be transmitted to the computer system 218 and management module. In the workflow 200, the computer system 218 and management module may determine the location of interaction and associate the location of the interaction with a particular bin at 222. In accordance with at least one embodiment, the signal information 220 may include signal information from one or more proximity sensors 216 of the inventory holder 204 and include data that identifies a relative strength of interactions relative to the location of the sensors on or within the inventory holder 204 and/or corresponding inventory bins such as inventory bin 214. For example, continuing the capacitive proximity sensor embodiment, the signal information from one or more proximity sensors 216 may include data that identifies various strengths of change in capacitance from the one or more capacitive proximity sensors associated with the inventory holder 204 and/or inventory bin 214. The computer system 218 and management module may determine a relative location of the interaction with the inventory holder 204 by the item 212 or user 208 by determining the location of the interaction based on the signal information 220 provided by the one or more proximity sensors 216 that detected or sensed the interaction by the item 212 or user 208. The signal information 220 may be measured as a strong or weak interaction based at least in part on the number of data points sensed or measured by the proximity sensors. For example, the one or more proximity sensors 216 may identify a greater number of data points or signals when the object has a greater circumference or other dimensions than an object with a smaller circumference or dimensions and/or is placed closer, deeper, or more proximal to one particular inventory bin rather than another particular inventory bin of the inventory holder. The signal information, signals, or data points may be identified by the number of intersection points between the inventory item 212 and/or user 208 and the proximity sensors. The signal information, signals, or number of data points may be measured at one or more points of time as well, such that a longer interaction with the one or more proximity sensors 216 may produce more data.

In some examples, the computer system 218 and management module may access a data store 224 with inventory holder information 226 associated with the inventory holder 204. The inventory holder information may comprise information about the inventory items that are stored with the inventory holders. For example, once a location of the interaction by an inventory item 212 is determined, a particular inventory bin that was utilized in the inventory related task or interacted with by inventory item 212 and/or user 208 may be associated with the inventory item 212 within database 224. The inventory holder information may be updated to associate the inventory item 212 with the particular inventory bin 214 and its location in the inventory holder 204. Other information may be included in the inventory holder information of data store 224 such as an indication of a successful stow or pick operation or a facing of the inventory holder 204 that the inventory item 212 was placed in with reference to the inventory bin 214. In some embodiments, the signal information including values or strength of signals provided by proximity sensors which may be associated with each inventory item and particular inventory bin location for subsequent analysis and error detection. In FIG. 2, the data store 224 maintains the signal information 228 identifying the relative strength of the signals provided by the one or more proximity sensors 216 and corresponding reference values for the strength of the interaction by the inventory item 212 and/or user 208 with each detecting or sensing proximity sensor of the inventory holder 204 and/or inventory bin 214. A location of the inventory item may be updated. The location may comprise a particular inventory holder, inventory bin, or other relevant information related to the location of the inventory item

In embodiments, the inventory holder information may include a mapping of locations of proximity sensors to corresponding inventory bins or with reference to the inventory holder itself. In some embodiments, instructions may be generated and presented to the user 208 to prohibit the placement of certain inventory items within certain inventory bins of an inventory holder in response to the signal information received from corresponding proximity sensors.

In a sample illustration, a user's hand and a basketball may be interacting with one or more proximity sensors of an inventory holder as the user places the basketball within a particular inventory bin of the inventory holder. The proximity sensors of the inventory holder and/or inventory bins may sense and/or detect the interaction of the objects with the inventory holder and/or inventory bins and transmit the signal information to the management module and/or computer system for analysis. The strength of the interactions by the objects with the detecting or sensing proximity sensors may be utilized to determine or locate the relative location of the interaction (placement of the basketball). For example, certain proximity sensors will detect a greater change in capacitance or a stronger interaction than other further away proximity sensors that are further from the placement of the basketball. The management module can utilize the signal information to determine the location of the interaction (placement of basketball by the user) with which to associate to a particular inventory bin and utilize a mapping of inventory bins to the determined location to identify the most proximal or relatively close inventory bin with which to associate with the detected interaction. Thereafter, the management module may update the inventory holder information for the inventory holder and inventory item to associate the inventory item with the particular bin and location of the particular bin for use in subsequent inventory related tasks.

In some examples, the system may provide feedback regarding a placed item. For example, the system could update a user interface to instruct the user to move the object into the inventory bin or another location in the inventory holder.

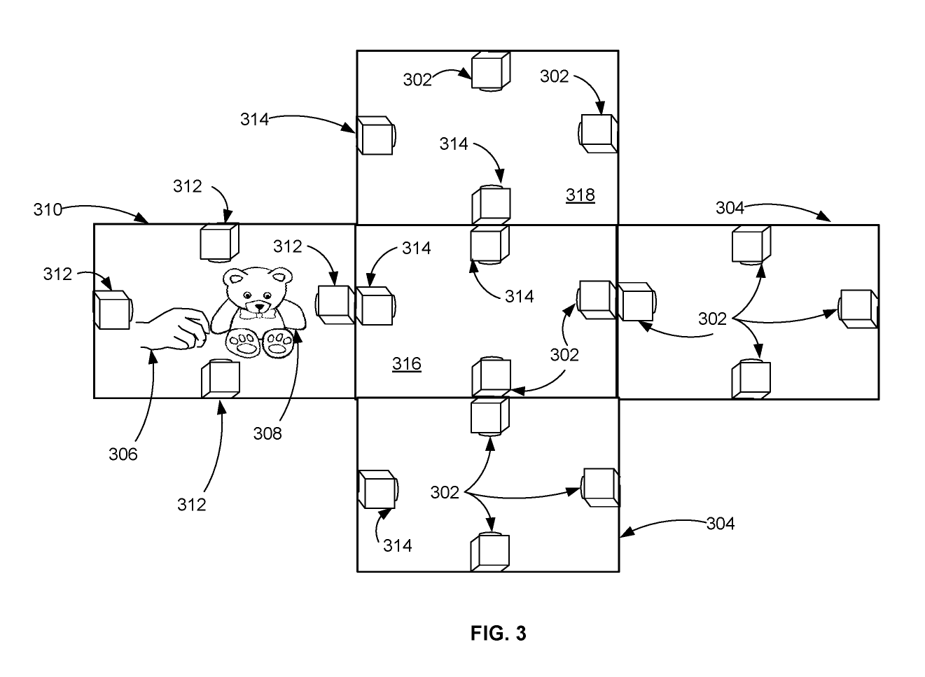

FIG. 3 illustrates an example configuration of inventory bins of an associated material holder with corresponding proximity sensors utilized in the inventory bin detection feature, in accordance with at least one embodiment. For example, different arrangements of sensors may be utilized for inventory holders that utilize a variable arrangement of columns and/or rows of inventory bins. As described herein, one or more proximity sensors 302 may be coupled with or otherwise associated with one or more inventory bins 304 of an inventory holder. In such configurations, the proximity sensors of a given inventory bin may detect an interaction by an object such as an inventory item and/or user placing, removing, or transferring said inventory item to and/or from the inventory bin/holder. FIG. 3 illustrates a user 306 placing an inventory item 308 within a particular inventory bin 310. The particular inventory bin 310 may include one or more proximity sensors 312. As the user 306 places the inventory item 308 within the particular inventory bin 310 the corresponding one or more proximity sensors 312 may detect and or sense the interaction such as by a change in an electric field provided by capacitive proximity sensors or in a magnetic field by inductive proximity sensors.

The one or more proximity sensors 312 may record or obtain signal information that identifies a strength of the interaction between the placement of the inventory item 308, user 306, and each of the one or more proximity sensors 312. For example, the signal information may include an identifier for each of the one or more proximity sensors 312 and a strength or value that represents the change in capacitance or induction caused by the placement of the inventory item 308 near the one or more proximity sensors 312. Proximity sensors 314 of nearby or proximal inventory bins, such as inventory bins 316 and 318 may also record or detect the interaction or placement of the inventory item 308 within the inventory bin 310. The proximity sensors 314 may also transmit or otherwise communicate associated signal information from their respective sensors to the management module. The management module may interpret and analyze the signal information from the proximity sensors 312 and 314 to determine a location of the placement of the inventory item 308 by user 306 (i.e., determine which particular inventory bin of a plurality of inventory bins were interacted with by an entity). In embodiments, the management module may utilize an algorithm that identifies the strongest interaction, or sum of detected signal strengths for sensors associated with particular bins,between the item placement and corresponding proximity sensors to determine a location of a particular inventory bin. For example, the algorithm may utilize the greatest change in capacitance or induction by certain proximity sensors, look up or otherwise access information that identifies a mapping of the proximity sensors to inventory bin locations, and determine the location of interaction by the inventory item 308 and user 306. In the example illustrated in FIG. 3, the management module would determine that the strongest signals are provided by proximity sensors 312 rather than proximity sensors 314 which are mapped to inventory bin 310 rather than inventory bin 316 or 318. The management module may update inventory holder information to associate the inventory item 308 with the inventory bin 310 and a location of inventory bin 310 within the corresponding inventory holder.

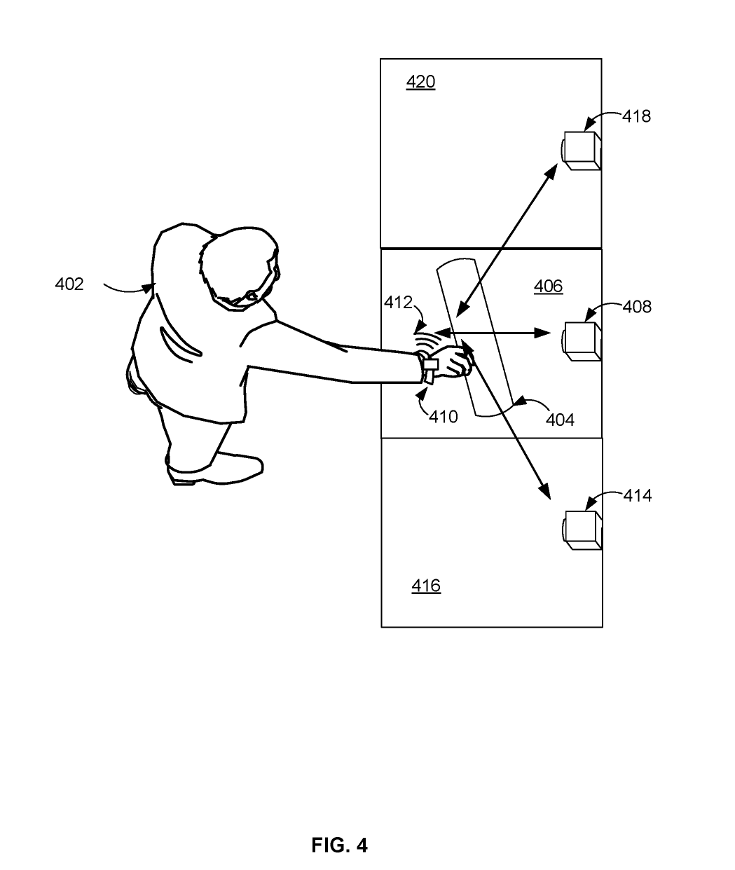

FIG. 4 illustrates an example configuration of inventory bins of an associated material holder with corresponding proximity sensors utilized in the inventory bin detection feature, in accordance with at least one embodiment. FIG. 4 includes a user 402 placing an inventory item 404 in inventory bin 406 of an inventory holder (not pictured). The inventory bin 406 may include a proximity sensor 408. The user 404 may be associated with or utilize a wearable device 410 that is configured to provide signals 412 via a transmitter to a receiver of the proximity sensor 408 and proximity sensor 414 of inventory bin 416 and proximity sensor 418 of inventory bin 420. In embodiments, the proximity sensors 408, 414, and 418 may include near field communication (NFC) sensors, radio frequency identification (RFID) sensors, inductive proximity sensors, or capacitive proximity sensors. The wearable device 410 may include a suitable transmitter configured to communicate with the proximity sensors 408, 414, and 418. For example, the proximity sensors 408, 414, and 418 may be ultra-wideband (UWB) radio receivers that are configured to receive signals from a UWB radio transmitter associated with the wearable device 410. As the user 408 places the inventory item 404 within inventory bin 406, the wearable device 410 may provide signals, data, or signal information 412 (illustrated as double sided arrows of FIG. 4) to the proximity sensors 408, 414, and 418, which may interpret the signal information 412 as an interaction by the user 402 and/or the inventory item 404 with inventory bins 406, 416, or 420.

As described herein, the signal information obtained or detected by the proximity sensors 408, 414, and 418 may be communicated or otherwise transmitted to the management module for use in analyzing or determining the location of the interaction with respect to the inventory holder that comprises the plurality of inventory bins such as inventory bins 406, 416, and 420. In embodiments, the management module may be configured to interpret the signal information from the proximity sensors 408, 414, and 418 to determine the location of the interaction. For example, the management module may determine that the strongest interaction is detected by proximity sensor 408 of corresponding inventory bin 406 rather than proximity sensor 414 or inventory bin 416 or proximity sensor 418 of inventory bin 420. In accordance with at least one embodiment, the management module may utilize inventory holder information that includes a mapping of locations of proximity sensors to inventory bins of an inventory holder to associate the location of the interaction with a particular inventory bin. The inventory item 404 may also be associated with the location of the particular inventory bin, in the present FIG. 4, inventory bin 406. In response to determining the location of the interaction (placement of inventory item 404 by user 402 in inventory bin 406), the management module may update or otherwise edit inventory holder information associated with the inventory holder corresponding to inventory bins 406, 416, and 420. For example, the updated inventory holder information may associate the inventory item 404 with a location of inventory bin 406 within the corresponding inventory holder. Subsequent inventory related tasks, such as the retrieval of inventory item 404 in response to a consumer ordering the inventory item 404, may be facilitated by the management module maintaining the inventory holder information and location of inventory item 404.

For example, instructions can be provided by the management module to move a mobile drive unit and dock the mobile drive unit to the inventory holder corresponding to the inventory bins 406, 416, and 420. The mobile drive unit may be instructed to move the inventory holder to a portion of a workspace, such as a station, and present a facing that enables access by an entity to the inventory bins 406, 416, and 420. The entity may then remove inventory item 404 for shipping and packaging processing. When the user 402 interacts (removes) the inventory item 404, the proximity sensors 408, 414, and 418 may receive new signal information or signals 412 from the transmitter associated with wearable device 410. The new signal information or signals 412 may be interpreted and analyzed by the management module to disassociate the inventory item from the location of the particular inventory bin 406 in response to the signal information or signals 412 provided during the interaction of the wearable device 410 and proximity sensors 408, 414, and 418.

As described herein, the proximity sensors 408, 414, and 418 may include an inductive proximity sensor configured to detect ferrous targets that change the reluctance or natural frequency of the magnetic circuit associated with the inductive proximity sensor. In such examples, the wearable device 410 may include or be comprised of ferrous material so as to trigger the detection of an interaction with inventory bins 406, 416, and 420 by the proximity sensors 408, 414, and 418. In examples where the proximity sensors 408, 414, and 418 includes an NFC sensor, the wearable device 410 may include a transmitter configured to send data or signals 412, such as radio waves or other data that can be received, detected, or sensed by a receiver of the proximity sensors 408, 414, and 418. In such examples, the wearable device 410 may induce electric currents of the proximity sensors 408, 414, and 418 which can be detected, recorded, and transmitted to the management module for use in determining a location of the interaction between the wearable device 410 (placing of inventory item 404 in inventory bin 406 by user 402) and an inventory holder corresponding to inventory bins 406, 416, and 420. In some examples where the proximity sensors 408, 414, and 418 includes an RFID sensor, the wearable device 410 may include an RFID tag and antenna that is configured to transmit the signals or signal information 412 via radio waves to the proximity sensors 408, 414, and 418 which can interpret the radio waves or signals 412 to determine an interaction between the inventory item 404 and inventory bins 406, 416, or 420 by the user 402. As with other proximity sensors, the signals or signal information 412 may be utilized to determine a location of the interaction or the location of the particular inventory bin of a plurality of inventory bins of an inventory holder that an item was stored or removed from by an entity.

FIG. 5 illustrates components of an inventory system according to a particular embodiment. FIG. 5 illustrates the components of an inventory system 10. Inventory system 10 includes a management module 15, which may implemented by computer system 218 of FIG. 2, one or more mobile drive units 20, one or more inventory holders 30, and one or more inventory stations 50. Mobile drive units 20 transport inventory holders 30 between points within a workspace 70 in response to commands communicated by management module 15. Each inventory holder 30 stores one or more types of inventory items with associated inventory bins. As a result, inventory system 10 is capable of moving inventory items between locations within workspace 70 to facilitate the entry, processing, and/or removal of inventory items from inventory system 10 and the completion of other tasks involving inventory items.

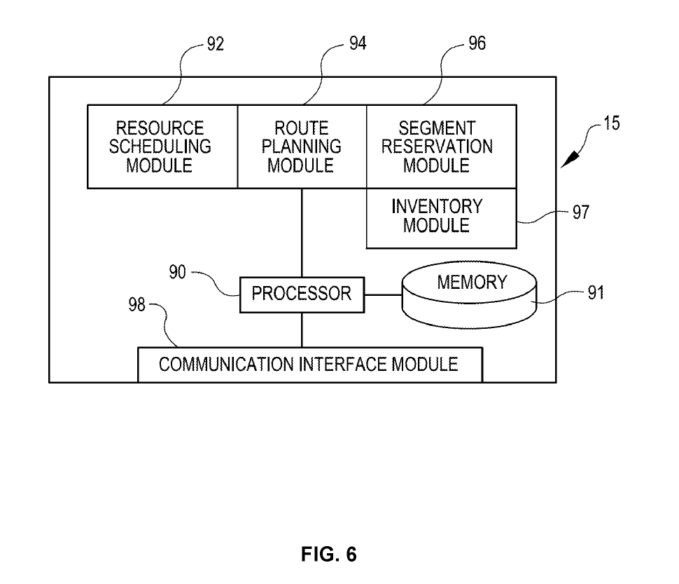

Management module 15 assigns tasks to appropriate components of inventory system 10 and coordinates operation of the various components in completing the tasks. These tasks may relate not only to the movement and processing of inventory items, but also to the management and maintenance of the components of inventory system 10. For example, management module 15 may assign portions of workspace 70 as parking spaces for mobile drive units 20, the scheduled recharge or replacement of mobile drive unit batteries, the storage of empty inventory holders 30, or any other operations associated with the functionality supported by inventory system 10 and its various components. Management module 15 may select components of inventory system 10 to perform these tasks and communicate appropriate commands and/or data to the selected components to facilitate completion of these operations. Although shown in FIG. 2 as a single, discrete component, management module 15 may represent multiple components and may represent or include portions of mobile drive units 20 or other elements of inventory system 10. As a result, any or all of the interactions between a particular mobile drive unit 20 and management module 15 that are described below may, in particular embodiments, represent peer-to-peer communication between that mobile drive unit 20 and one or more other mobile drive units 20. The components and operation of an example embodiment of management module 15 are discussed further below with respect to FIG. 6.

Mobile drive units 20 move inventory holders 30 between locations within workspace 70. Mobile drive units 20 may represent any devices or components appropriate for use in inventory system 10 based on the characteristics and configuration of inventory holders 30 and/or other elements of inventory system 10. In a particular embodiment of inventory system 10, mobile drive units 20 represent independent, self-powered devices configured to freely move about workspace 70. Examples of such inventory systems are disclosed in U.S. Pat. No. 9,087,314, issued on Jul. 21, 2015, titled “SYSTEM AND METHOD FOR POSITIONING A MOBILE DRIVE UNIT” and U.S. Pat. No. 8,280,547, issued on Oct. 2, 2012, titled “METHOD AND SYSTEM FOR TRANSPORTING INVENTORY ITEMS”, the entire disclosures of which are herein incorporated by reference. In alternative embodiments, mobile drive units 20 represent elements of a tracked inventory system configured to move inventory holder 30 along tracks, rails, cables, crane system, or other guidance or support elements traversing workspace 70. In such an embodiment, mobile drive units 20 may receive power and/or support through a connection to the guidance elements, such as a powered rail. Additionally, in particular embodiments of inventory system 10 mobile drive units 20 may be configured to utilize alternative conveyance equipment to move within workspace 70 and/or between separate portions of workspace 70. In some embodiments, the inventory holders 30 may represent independent, self-powered devices associated with the management module 15 or in communication with management module 15. In such configurations, the inventory holders may be recharged while interacting with mobile drive units 20, such as via a corresponding battery, or when interacting with inventory stations 50.

Additionally, mobile drive units 20 may be capable of communicating with management module 15 to receive information identifying selected inventory holders 30, transmit the locations of mobile drive units 20, or exchange any other suitable information to be used by management module 15 or mobile drive units 20 during operation. Mobile drive units 20 may communicate with management module 15 wirelessly, using wired connections between mobile drive units 20 and management module 15, and/or in any other appropriate manner. As one example, particular embodiments of mobile drive unit 20 may communicate with management module 15 and/or with one another using 802.11, Bluetooth, or Infrared Data Association (IrDA) standards, or any other appropriate wireless communication protocol. As another example, in a tracked inventory system 10, tracks or other guidance elements upon which mobile drive units 20 move may be wired to facilitate communication between mobile drive units 20 and other components of inventory system 10. Furthermore, management module 15 may include components of individual mobile drive units 20 and/or inventory holders 30. Thus, for the purposes of this description and the claims that follow, communication between management module 15 and a particular mobile drive unit 20 or inventory holder 30 may represent communication between components of a particular mobile drive unit 20 and/or inventory holder 30. In general, mobile drive units 20 may be powered, propelled, and controlled in any manner appropriate based on the configuration and characteristics of inventory system 10.

Inventory holders 30 store inventory items. In a particular embodiment, inventory holders 30 include multiple storage bins (inventory bins) with each storage bin capable of holding one or more types of inventory items. Inventory holders 30 are capable of being carried, rolled, and/or otherwise moved by mobile drive units 20. In particular embodiments, inventory holder 30 may provide additional propulsion to supplement that provided by mobile drive unit 20 when moving inventory holder 30.

Additionally, in particular embodiments, inventory items 40 may also hang from hooks or bars (not shown) within or on inventory holder 30. In general, inventory holder 30 may store inventory items 40 in any appropriate manner within inventory holder 30 and/or on the external surface of inventory holder 30.

Additionally, each inventory holder 30 may include a plurality of faces, and each bin may be accessible through one or more faces of the inventory holder 30. For example, in a particular embodiment, inventory holder 30 includes four faces. In such an embodiment, bins located at a corner of two faces may be accessible through either of those two faces, while each of the other bins is accessible through an opening in one of the four faces. Mobile drive unit 20 may be configured to rotate inventory holder 30 at appropriate times to present a particular face and the bins associated with that face to an operator or other components of inventory system 10. In some embodiments, the management module 15 may provide instructions to active a portion of corresponding proximity sensors of an inventory holder 30 based on the particular face that is facing an operator. In such cases, the proximity sensors may be in a state of inactivity until instructions are received. In an embodiment, the proximity sensors are always active and may receive instructions to de-activate proximity sensors of facings that are not facing an operator during an inventory related task.

Inventory items represent any objects suitable for storage, retrieval, and/or processing in an automated inventory system 10. For the purposes of this description, “inventory items” may represent any one or more objects of a particular type that are stored in inventory system 10. Thus, a particular inventory holder 30 is currently “storing” a particular inventory item if the inventory holder 30 currently holds one or more units of that type. As one example, inventory system 10 may represent a mail order warehouse facility, and inventory items may represent merchandise stored in the warehouse facility. During operation, mobile drive units 20 may retrieve inventory holders 30 containing one or more inventory items requested in an order to be packed for delivery to a customer or inventory holders 30 carrying pallets containing aggregated collections of inventory items for shipment. Moreover, in particular embodiments of inventory system 10, boxes containing completed orders may themselves represent inventory items.

In particular embodiments, inventory system 10 may also include one or more inventory stations 50. Inventory stations 50 represent locations designated for the completion of particular tasks involving inventory items. Such tasks may include the removal of inventory items from inventory holders 30, the introduction of inventory items into inventory holders 30, the counting of inventory items in inventory holders 30, the decomposition of inventory items (e.g. from pallet- or case-sized groups to individual inventory items), the consolidation of inventory items between inventory holders 30, and/or the processing or handling of inventory items in any other suitable manner. In particular embodiments, inventory stations 50 may just represent the physical locations where a particular task involving inventory items may be completed within workspace 70. In alternative embodiments, inventory stations 50 may represent both the physical location and also any appropriate equipment for processing or handling inventory items, such as scanners for monitoring the flow of inventory items in and out of inventory system 10, communication interfaces for communicating with management module 15, and/or any other suitable components. Inventory stations 50 may be controlled, entirely or in part, by human operators or may be fully automated. Moreover, the human or automated operators of inventory stations 50 may be capable of performing certain tasks to inventory items, such as packing, counting, or transferring inventory items, as part of the operation of inventory system 10.

Workspace 70 represents an area associated with inventory system 10 in which mobile drive units 20 may move and/or inventory holders 30 may be stored. For example, workspace 70 may represent all or part of the floor of a mail-order warehouse in which inventory system 10 operates. Although FIG. 2 shows, for the purposes of illustration, an embodiment of inventory system 10 in which workspace 70 includes a fixed, predetermined, and finite physical space, particular embodiments of inventory system 10 may include mobile drive units 20 and inventory holders 30 that are configured to operate within a workspace 70 that is of variable dimensions and/or an arbitrary geometry. While FIG. 2 illustrates a particular embodiment of inventory system 10 in which workspace 70 is entirely enclosed in a building, alternative embodiments may utilize workspaces 70 in which some or all of the workspace 70 is located outdoors, within a vehicle (such as a cargo ship), or otherwise unconstrained by any fixed structure.

In operation, management module 15 selects appropriate components to complete particular tasks and transmits task assignments 18 to the selected components to trigger completion of the relevant tasks. Each task assignment 18 defines one or more tasks to be completed by a particular component. These tasks may relate to the retrieval, storage, replenishment, and counting of inventory items and/or the management of mobile drive units 20, inventory holders 30, inventory stations 50 and other components of inventory system 10. Depending on the component and the task to be completed, a particular task assignment 18 may identify locations, components, and/or actions associated with the corresponding task and/or any other appropriate information to be used by the relevant component in completing the assigned task.

In particular embodiments, management module 15 generates task assignments 18 based, in part, on inventory requests that management module 15 receives from other components of inventory system 10 and/or from external components in communication with management module 15. These inventory requests identify particular operations to be completed involving inventory items stored or to be stored within inventory system 10 and may represent communication of any suitable form. For example, in particular embodiments, an inventory request may represent a shipping order specifying particular inventory items that have been purchased by a customer and that are to be retrieved from inventory system 10 for shipment to the customer. Management module 15 may also generate task assignments 18 independently of such inventory requests, as part of the overall management and maintenance of inventory system 10. For example, management module 15 may generate task assignments 18 in response to the occurrence of a particular event (e.g., in response to a mobile drive unit 20 requesting a space to park), according to a predetermined schedule (e.g., as part of a daily start-up routine), or at any appropriate time based on the configuration and characteristics of inventory system 10. After generating one or more task assignments 18, management module 15 transmits the generated task assignments 18 to appropriate components for completion of the corresponding task. The relevant components then execute their assigned tasks.

With respect to mobile drive units 20 specifically, management module 15 may, in particular embodiments, communicate task assignments 18 to selected mobile drive units 20 that identify one or more destinations for the selected mobile drive units 20. Management module 15 may select a mobile drive unit 20 to assign the relevant task based on the location or state of the selected mobile drive unit 20, an indication that the selected mobile drive unit 20 has completed a previously-assigned task, a predetermined schedule, and/or any other suitable consideration. These destinations may be associated with an inventory request the management module 15 is executing or a management objective the management module 15 is attempting to fulfill. For example, the task assignment may define the location of an inventory holder 30 to be retrieved, an inventory station 50 to be visited, a storage location where the mobile drive unit 20 should park until receiving another task, or a location associated with any other task appropriate based on the configuration, characteristics, and/or state of inventory system 10, as a whole, or individual components of inventory system 10. For example, in particular embodiments, such decisions may be based on the popularity of particular inventory items, the staffing of a particular inventory station 50, the tasks currently assigned to a particular mobile drive unit 20, and/or any other appropriate considerations.

As part of completing these tasks mobile drive units 20 may dock with and transport inventory holders 30 within workspace 70. Mobile drive units 20 may dock with inventory holders 30 by connecting to, lifting, and/or otherwise interacting with inventory holders 30 in any other suitable manner so that, when docked, mobile drive units 20 are coupled with and/or support inventory holders 30 and may move inventory holders 30 within workspace 70. While the description below focuses on particular embodiments of mobile drive unit 20 and inventory holder 30 that are configured to dock in a particular manner, alternative embodiments of mobile drive unit 20 and inventory holder 30 may be configured to dock in any manner suitable to allow mobile drive unit 20 to move inventory holder 30 within workspace 70. Additionally, as noted below, in particular embodiments, mobile drive units 20 represent all or portions of inventory holders 30. In such embodiments, mobile drive units 20 may not dock with inventory holders 30 before transporting inventory holders 30 and/or mobile drive units 20 may each remain continually docked with a particular inventory holder 30.

While the appropriate components of inventory system 10 complete assigned tasks, management module 15 may interact with the relevant components to ensure the efficient use of space, equipment, manpower, and other resources available to inventory system 10. As one specific example of such interaction, management module 15 is responsible, in particular embodiments, for planning the paths mobile drive units 20 take when moving within workspace 70 and for allocating use of a particular portion of workspace 70 to a particular mobile drive unit 20 for purposes of completing an assigned task. In such embodiments, mobile drive units 20 may, in response to being assigned a task, request a path to a particular destination associated with the task. Moreover, while the description below focuses on one or more embodiments in which mobile drive unit 20 requests paths from management module 15, mobile drive unit 20 may, in alternative embodiments, generate its own paths.

Components of inventory system 10 may provide information to management module 15 regarding their current state, other components of inventory system 10 with which they are interacting, and/or other conditions relevant to the operation of inventory system 10. This may allow management module 15 to utilize feedback from the relevant components to update algorithm parameters, adjust policies, or otherwise modify its decision-making to respond to changes in operating conditions or the occurrence of particular events.

In addition, while management module 15 may be configured to manage various aspects of the operation of the components of inventory system 10, in particular embodiments, the components themselves may also be responsible for decision-making relating to certain aspects of their operation, thereby reducing the processing load on management module 15.

Thus, based on its knowledge of the location, current state, and/or other characteristics of the various components of inventory system 10 and an awareness of all the tasks currently being completed, management module 15 may generate tasks, allot usage of system resources, and otherwise direct the completion of tasks by the individual components in a manner that optimizes operation from a system-wide perspective. Moreover, by relying on a combination of both centralized, system-wide management and localized, component-specific decision-making, particular embodiments of inventory system 10 may be able to support a number of techniques for efficiently executing various aspects of the operation of inventory system 10. As a result, particular embodiments of management module 15 may, by implementing one or more management techniques described below, enhance the efficiency of inventory system 10 and/or provide other operational benefits.

FIG. 6 illustrates in greater detail the components of a particular embodiment of management module 15 which may be implemented by computer system 218 of FIG. 2. As shown, the example embodiment includes a resource scheduling module 92, a route planning module 94, a segment reservation module 96, an inventory module 97, a communication interface module 98, a processor 90, and a memory 91. Management module 15 may represent a single component, multiple components located at a central location within inventory system 10, or multiple components distributed throughout inventory system 10. For example, management module 15 may represent components of one or more mobile drive units 20 that are capable of communicating information between the mobile drive units 20 and coordinating the movement of mobile drive units 20 within workspace 70. In general, management module 15 may include any appropriate combination of hardware and/or software suitable to provide the described functionality.

Processor 90 is operable to execute instructions associated with the functionality provided by management module 15. Processor 90 may comprise one or more general purpose computers, dedicated microprocessors, or other processing devices capable of communicating electronic information. Examples of processor 90 include one or more application-specific integrated circuits (ASICs), field programmable gate arrays (FPGAs), digital signal processors (DSPs) and any other suitable specific or general purpose processors.

Memory 91 stores processor instructions, inventory requests, reservation information, state information for the various components of inventory system 10 and/or any other appropriate values, parameters, or information utilized by management module 15 during operation. Memory 91 may represent any collection and arrangement of volatile or nonvolatile, local or remote devices suitable for storing data. Examples of memory 91 include, but are not limited to, random access memory (RAM) devices, read only memory (ROM) devices, magnetic storage devices, optical storage devices or any other suitable data storage devices.

Resource scheduling module 92 processes received inventory requests and generates one or more assigned tasks to be completed by the components of inventory system 10. Resource scheduling module 92 may also select one or more appropriate components for completing the assigned tasks and, using communication interface module 98, communicate the assigned tasks to the relevant components. Additionally, resource scheduling module 92 may also be responsible for generating assigned tasks associated with various management operations, such as prompting mobile drive units 20 to recharge batteries or have batteries replaced, instructing inactive mobile drive units 20 to park in a location outside the anticipated traffic flow or a location near the anticipated site of future tasks, and/or directing mobile drive units 20 selected for repair or maintenance to move towards a designated maintenance station.

Route planning module 94 receives route requests from mobile drive units 20. These route requests identify one or more destinations associated with a task the requesting mobile drive unit 20 is executing. In response to receiving a route request, route planning module 94 generates a path to one or more destinations identified in the route request. Route planning module 94 may implement any appropriate algorithms utilizing any appropriate parameters, factors, and/or considerations to determine the appropriate path. After generating an appropriate path, route planning module 94 transmits a route response identifying the generated path to the requesting mobile drive unit 20 using communication interface module 98.

Segment reservation module 96 receives reservation requests from mobile drive units 20 attempting to move along paths generated by route planning module 94. These reservation requests request the use of a particular portion of workspace 70 (referred to herein as a “segment”) to allow the requesting mobile drive unit 20 to avoid collisions with other mobile drive units 20 while moving across the reserved segment. In response to received reservation requests, segment reservation module 96 transmits a reservation response granting or denying the reservation request to the requesting mobile drive unit 20 using the communication interface module 98.

The inventory module 97 maintains information about the location and number of inventory items in the inventory system 10. Information may be maintained about the number of inventory items in a particular inventory holder 30, and the maintained information may include the location of those inventory items in the inventory holder 30 including the association of each inventory item with a particular inventory bin of the inventory holder 30. The inventory module 97 may also communicate with the mobile drive units 20, utilizing task assignments 18 to maintain, replenish, or move inventory items within the inventory system 10. In accordance with at least one embodiment, the inventory module 97 may utilize the signal information from one or more proximity sensors of an inventory holder 30 and/or associated inventory bins to determine the location of an interaction related to an inventory task (storing, picking, or transferring of inventory items) with an inventory holder 30. The inventory module 97 may utilize an algorithm to interpret and analyze the signal information provided by proximity sensors in response to detecting an interaction with the inventory holder 30 or associated inventory bins. In embodiments, the algorithm may utilize the strongest signals of interaction or greatest change in capacitance or induction from the various proximity sensors to determine a location of a proximal inventory bin to the interaction. For example, the inventory module 97 may access and maintain inventory holder information that identifies the location of each proximity sensor relative to each inventory bin of the inventory holder. The mapping of proximity sensors and inventory bins may be utilized, along with the signal information, to determine a location of a particular inventory bin to associate with an interaction by a user and/or inventory item with the inventory holder. The inventory module 97 may associate the inventory item with the particular inventory bin and the location of the particular inventory bin for use in subsequent inventory related tasks. In accordance with at least one embodiment, the inventory module 97 may maintain one or more threshold values which may be used to filer or further analyze the signal information provided by the proximity sensors. For example, the algorithm utilized by the inventory module 97 may ignore certain signals or data points that identify an interaction or strength of signal that is below a threshold to aid in identifying the location of a particular inventory bin interacted with by an inventory item and/or user.

Communication interface module 98 facilitates communication between management module 15 and other components of inventory system 10, including reservation responses, reservation requests, route requests, route responses, and task assignments. These reservation responses, reservation requests, route requests, route responses, and task assignments may represent communication of any form appropriate based on the capabilities of management module 15 and may include any suitable information. Depending on the configuration of management module 15, communication interface module 98 may be responsible for facilitating either or both of wired and wireless communication between management module 15 and the various components of inventory system 10. In particular embodiments, management module 15 may communicate using communication protocols such as 802.11, Bluetooth, or Infrared Data Association (IrDA) standards. Furthermore, management module 15 may, in particular embodiments, represent a portion of mobile drive unit 20 or other components of inventory system 10. In such embodiments, communication interface module 98 may facilitate communication between management module 15 and other parts of the same system component.

In general, resource scheduling module 92, route planning module 94, segment reservation module 96, inventory module 97, and communication interface module 98 may each represent any appropriate hardware and/or software suitable to provide the described functionality. In addition, as noted above, management module 15 may, in particular embodiments, represent multiple different discrete components and any or all of resource scheduling module 92, route planning module 94, segment reservation module 96, inventory module 97, and communication interface module 98 may represent components physically separate from the remaining elements of management module 15. Moreover, any two or more of resource scheduling module 92, route planning module 94, segment reservation module 96, inventory module 97, and communication interface module 98 may share common components. For example, in particular embodiments, resource scheduling module 92, route planning module 94, segment reservation module 96, and inventory module 97 represent computer processes executing on processor 90 and communication interface module 98 comprises a wireless transmitter, a wireless receiver, and a related computer process executing on processor 90. In embodiments, the resource scheduling module 97, the route planning module 94, the inventory module 97, and the communication interface module 98 may be configured to receive and process a request, by an entity or associate, requesting access to a particular inventory holder 30. The resource scheduling module 97, the route planning module 94, the inventory module 97, and the communication interface module 98 may identify an appropriate facing to enable access by the requesting entity using information associated with the request, for example an identifier of a particular inventory item, to access particular bins that are accessible by certain facings of the inventory holder 30. The inventory module 97 may communicate or transmit instructions to active or enable certain portions of proximity sensors associated with a particular facing of the inventory holder 30 for determining the location of an interaction with an inventory item by the requesting entity.

FIG. 7 illustrates an example inventory holder that may be utilized in particular embodiments of the inventory system. The structure and contents of one side of an example inventory holder 30 is illustrated and may comprise any number of faces with similar or different structure. As illustrated, inventory holder 30 includes a frame 710, a plurality of legs 728, and a docking surface 750.

Frame 710 holds inventory items 40. Frame 710 provides storage space for storing inventory items 40 external or internal to frame 710. The storage space provided by frame 710 may be divided into a plurality of inventory bins 720, each capable of holding inventory items 40. Inventory bins 720 may include any appropriate storage elements, such as bins, compartments, or hooks. In accordance with a t least one embodiment, inventory bins 720 may be comprised of non-rigid materials such as cloths, fabric, or other suitable woven material so as to flex, bend, or otherwise give the shape of the inventory bins 720 in response to receiving items 40. Frame 710 may include one or more proximity sensors 765 configured to detect/sense an interaction with the inventory holder 30, frame 710, and/or inventory bins 720. In embodiments, the frame 710, the plurality of inventory bins 720 and/or the adjustable dividers 724 may be coupled with, associated with, or otherwise bodily incorporate the one or more proximity sensors 765. For example, the one or more proximity sensors 765 may be interwoven, threaded, or otherwise bodily incorporated into the cloth or fabric material comprising the inventory bins 720, frame 710, or inventory holder 30. In some embodiments, the facing and/or frame 710 of inventory holder 30 may be comprised of one or more proximity sensors 765 with a portion of the sensors arranged in a vertical fashion with respect to the facing of the inventory holder 30 and another portion of the sensors arranged in a horizontal fashion with respect to the facing of the inventory holder 30. In embodiments, the facing and/or frame 710 of inventory holder 30 may be comprised of a proximity sensors 765.

In a particular embodiment, frame 710 is composed of a plurality of trays 722 stacked upon one another and attached to or stacked on a base 718. In such an embodiment, inventory bins 720 may be formed by a plurality of adjustable dividers 724 that may be moved to resize one or more inventory bins 720. In alternative embodiments, frame 710 may represent a single inventory bin 720 that includes a single tray 722 and no adjustable dividers 724. Additionally, in particular embodiments, frame 710 may represent a load-bearing surface mounted on mobility element 730. Inventory items 40 may be stored on such an inventory holder 30 by being placed on frame 710. In general, frame 710 may include internal and/or external storage space divided into any appropriate number of inventory bins 720 in any appropriate manner.

Additionally, in a particular embodiment, frame 710 may include a plurality of device openings 726 that allow mobile drive unit 20 to position a docking head to adjacent docking surface 750. The size, shape, and placement of device openings 726 may be determined based on the size, the shape, and other characteristics of the particular embodiment of mobile drive unit 20 and/or inventory holder 30 utilized by inventory system 10. For example, in the illustrated embodiment, frame 710 includes four legs 728 that form device openings 726 and allow mobile drive unit 20 to position mobile drive unit 20 under frame 710 and adjacent to docking surface 750. The length of legs 728 may be determined based on a height of mobile drive unit 20.

Docking surface 750 comprises a portion of inventory holder 30 that couples to, abuts, and/or rests upon a portion of a docking head when mobile drive unit 20 is docked to inventory holder 30. Additionally, docking surface 750 supports a portion or all of the weight of inventory holder 30 while inventory holder 30 is docked with mobile drive unit 20. The composition, shape, and/or texture of docking surface 750 may be designed to facilitate maneuvering of inventory holder 30 by mobile drive unit 20. For example, as noted above, in particular embodiments, docking surface 750 may comprise a high-friction portion. When mobile drive unit 20 and inventory holder 30 are docked, frictional forces induced between the docking head and this high-friction portion may allow mobile drive unit 20 to maneuver inventory holder 30. Additionally, in particular embodiments, docking surface 750 may include appropriate components suitable to receive a portion of docking head, couple inventory holder 30 to mobile drive unit 20, and/or facilitate control of inventory holder 30 by mobile drive unit 20.

Holder identifier 760 marks a predetermined portion of inventory holder 30 and mobile drive unit 20 may use holder identifier 760 to align with inventory holder 30 during docking and/or to determine the location of inventory holder 30. More specifically, in particular embodiments, mobile drive unit 20 may be equipped with components, such as holder sensor, that may detect holder identifier 760 and determine its location relative to mobile drive unit 20. As a result, mobile drive unit 20 may be able to determine the location of inventory holder 30 as a whole. For example, in particular embodiments, holder identifier 760 may represent a reflective marker that is positioned at a predetermined location on inventory holder 30 and that the holder sensor may optically detect using an appropriately-configured camera.

Depending on the configuration and characteristics of mobile drive unit 20 and inventory system 10, mobile drive unit 20 may move inventory holder 30 using a variety of appropriate methods. In a particular embodiment, mobile drive unit 20 is capable of moving inventory holder 30 along a two-dimensional grid, combining movement along straight-line segments with ninety-degree rotations and arcing paths to transport inventory holder 30 from the first location to the second location. Additionally, while moving, mobile drive unit 20 may use fixed objects located in the workspace as reference points to assist in navigation. For example, in particular embodiments, inventory system 10 includes multiple fiducial marks. Mobile drive unit 20 may be configured to detect fiducial marks and to determine the location of mobile drive unit 20 and/or measure its movement based on the detection of fiducial marks.

After mobile drive unit 20 arrives at the second location, mobile drive unit 20 may perform appropriate operations to facilitate access to inventory items 40 stored in inventory holder 30. For example, mobile drive unit 20 may rotate inventory holder 30 to present a particular face of inventory holder 30 to an operator of inventory system 10 or other suitable party, such as a user (e.g., packer) selecting inventory items 40 from inventory holder 30. Mobile drive unit 20 may also undock from inventory holder 30. Alternatively, instead of undocking at the second location, mobile drive unit 20 may transport inventory holder 30 back to the first location or to a third location after any appropriate actions have been taken involving inventory items 40. For example, after the user has removed particular inventory items 40 from inventory holder 30, mobile drive unit 20 may return inventory holder 30 to its original storage location, a new storage location, or another inventory station. Mobile drive unit 20 may then undock from inventory holder 30 at this new location.

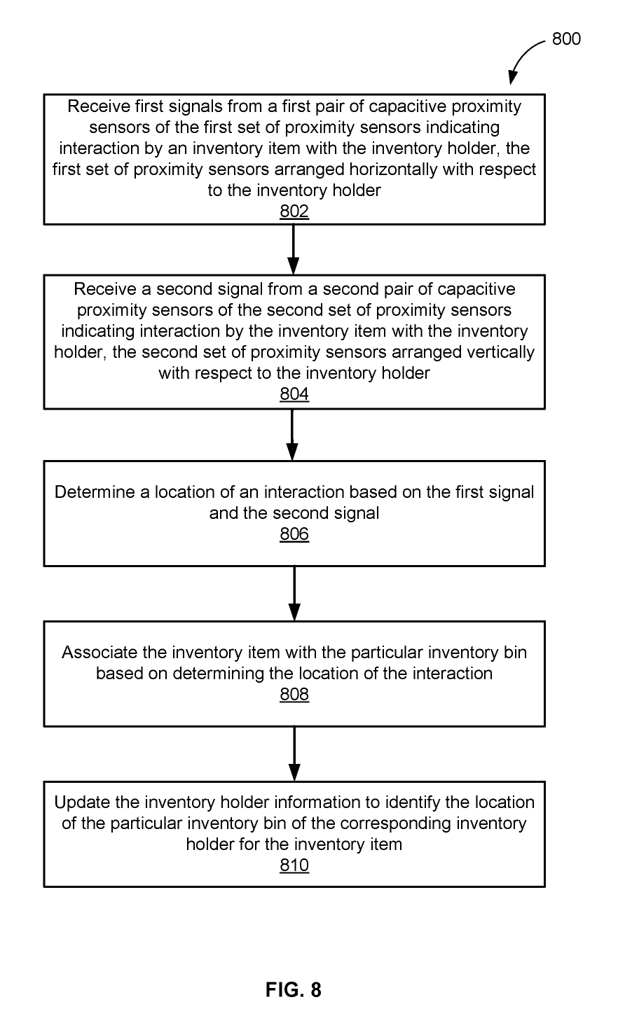

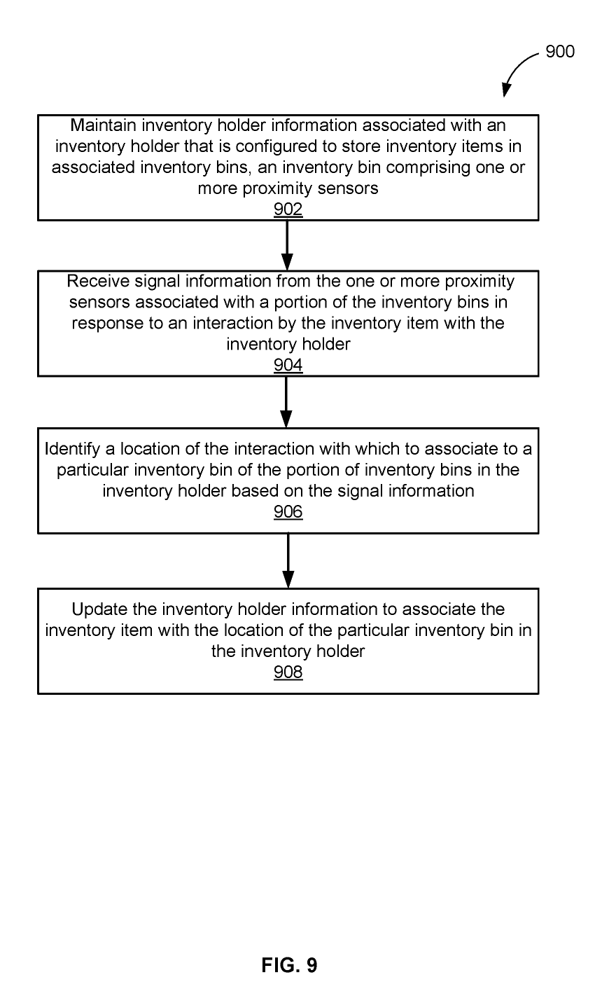

FIGS. 8 and 9 illustrate example flow charts for an inventory bin detection feature, according to embodiments. These processes are illustrated as a logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer executable instructions include routines, programs, objects, components, data structures, and the like that perform particular functions or implement particular data types. The order in which the operations are described is not intended to be construed as a limitation, and any number of the described operations can be combined in any order and/or in parallel to implement the process.

Additionally, some, any, or all of the process (or any other processes described herein, or variations and/or combination thereof) may be performed under the control of one or more computer systems configured with executable instructions and may be implemented as code (e.g., executable instructions, one or more computer programs, or one or more applications) executing collectively on one or more processors, by hardware or combinations thereof. As noted above, the code may be stored on a computer-readable storage medium, for example, in the form of a computer program including a plurality of instructions executable by one or more processors. The computer-readable storage medium may be non-transitory.

In some examples, the inventory management system utilizing at least the computer system 218 of FIG. 2 and/or the management module 15 may perform the processes 800 and 900 of FIGS. 8 and 9. In FIG. 8, the process 800 may include receiving a first signal from a first pair of capacitive proximity sensors of the first set of proximity sensors indicating an interaction by an inventory item with the inventory holder at 802. For example, the first set of proximity sensors may include a set of proximity sensors arranged or configured in a vertical fashion with respect to a facing of an inventory holder and a second set of proximity sensors may include another set of proximity sensors arranged or configured in a horizontal fashion with respect to a facing of the inventory holder. In some embodiments, the first set of proximity sensors may include a portion of proximity sensors associated with a first inventory bin of an inventory holder whereas a second set of proximity sensors may include another portion of proximity sensors associated with a second and/or neighboring inventory bin to the first inventory bin. The process 800 may include receiving a second signal from a second pair of capacitive proximity sensors of the second set of proximity sensors indicating interaction by the inventory item with the inventory holder at 804.

The process 800 may include determining a location of an interaction based on the first signal and the second signal at 806. For example, the management module may utilize the first signal and second signal to determine a relative location of an interaction with the inventory bins and/or inventory holder. For example, the interaction may be an entity or inventory item interacting with the inventory bins and/or inventory holder. In embodiments, the management module may analyze the received or obtained signal information to determine a strongest interaction by particular proximity sensors or along a line of proximity sensors in the vertical and horizontal configuration of sensors that identify the likely location for the interaction. For example, the proximity sensors could include capacitive sensors and the first signal and second signal could include information that identifies a range of values that represent a change in capacitance for corresponding proximity sensors. The management module may utilize the strongest chance in capacitance to identify with the location of interaction. The process 800 may associate the inventory item with the particular inventory bin based on the determination of the interaction using the first signal and the second signal at 808. The process 800 may conclude at 810 by updating the inventory holder information for the inventory holder to identify the location of the particular inventory bin of the corresponding inventory holder for the inventory item. The inventory holder information may associate an identifier of the inventory item with another identifier that corresponds to the location for the particular inventory bin for the corresponding inventory holder for use in subsequent inventory related tasks. The management module may update or otherwise communicate with a data store to update the inventory holder information such as by making database entries or editing previously provided database entries to reflect the association of the inventory item with the particular inventory bin.

The process 900 may include maintaining inventory holder information associated with an inventory holder that is configured to store inventory items in associated inventory bins where an inventory bin comprises one or more proximity sensors at 902. In embodiments, each inventory bin of a plurality of inventory bins may include one or more proximity sensors that are coupled with, associated, or otherwise bodily incorporated to the walls of each inventory bin. The process 900 may include receiving signal information from the one or more proximity sensors associated with a portion of the inventory bins at 904 in response to an interaction by the inventory item with the inventory holder. The process may include identifying a location of the interaction with which to associate to a particular inventory bin of the portion of inventory bins in the inventory holder based on the signal information at 906. For example, the management module may utilize the strength of interactions or values included in the signal values to determine an approximate location of the interaction detected by the one or more proximity sensors with which to associate with the portion of inventory bins or to a particular inventory bin. The management module may maintain and access inventory holder information that includes a mapping of proximity sensors to bin locations on a corresponding inventory holder. The process 900 may conclude at 908 by updating the inventory holder information to associate the inventory item with the location of the particular inventory bin in the inventory holder. As described herein, the management module may update the inventory holder information to disassociate the inventory item from a particular inventory bin based on the state of a particular inventory bin as included by the inventory holder information. For example, the inventory holder information may identify a bin as associated with an item thereby denoting a successful store operation and when subsequent signal information identifies an interaction at the same inventory bin, the inventory holder information may be updated to disassociate the inventory item from the particular inventory bin to denote a successful pick or transfer operation of the inventory item from the particular inventory bin.

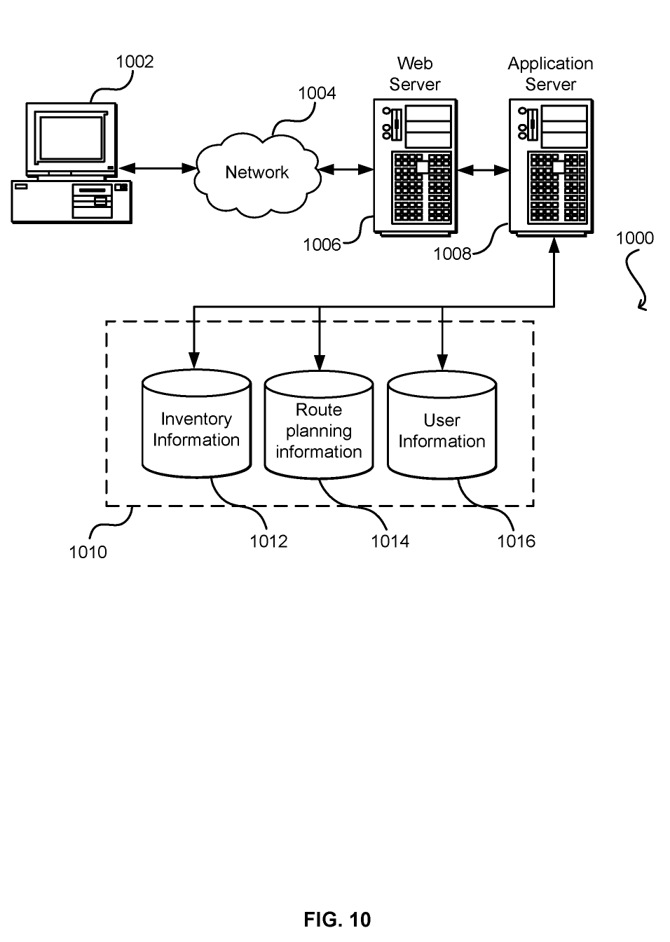

FIG. 10 illustrates aspects of an example environment 1000 for implementing aspects in accordance with various embodiments. As will be appreciated, although a Web-based environment is used for purposes of explanation, different environments may be used, as appropriate, to implement various embodiments. The environment includes an electronic client device 1002, which may include any appropriate device operable to send and receive requests, messages, or information over an appropriate network 1004 and convey information back to a user of the device. Examples of such client devices include personal computers, cell phones, handheld messaging devices, laptop computers, set-top boxes, personal data assistants, electronic book readers, and the like. The network may include any appropriate network, including an intranet, the Internet, a cellular network, a local area network or any other such network or combination thereof. Components used for such a system may depend at least in part upon the type of network and/or environment selected. Protocols and components for communicating via such a network are well known and will not be discussed herein in detail. Communication over the network may be enabled by wired or wireless connections and combinations thereof. In this example, the network includes the Internet, as the environment includes a Web server 1006 for receiving requests and serving content in response thereto, although for other networks an alternative device serving a similar purpose could be used as would be apparent to one of ordinary skill in the art.

The illustrative environment includes at least one application server 1008 and a data store 1010. It should be understood that there may be several application servers, layers, or other elements, processes or components, which may be chained or otherwise configured, which may interact to perform tasks such as obtaining data from an appropriate data store. As used herein the term “data store” refers to any device or combination of devices capable of storing, accessing, and retrieving data, which may include any combination and number of data servers, databases, data storage devices and data storage media, in any standard, distributed or clustered environment. The application server may include any appropriate hardware and software for integrating with the data store as needed to execute aspects of one or more applications for the client device, handling a majority of the data access and business logic for an application. The application server provides access control services in cooperation with the data store and is able to generate content such as text, graphics, audio and/or video to be transferred to the user, which may be served to the user by the Web server in the form of HyperText Markup Language (“HTML”), Extensible Markup Language (“XML”) or another appropriate structured language in this example. The handling of all requests and responses, as well as the delivery of content between the client device 1002 and the application server 1008, may be handled by the Web server 1006. It should be understood that the Web 1006 and application servers 1008 are not required and are merely example components, as structured code discussed herein may be executed on any appropriate device or host machine as discussed elsewhere herein.

The data store 1010 may include several separate data tables, databases or other data storage mechanisms and media for storing data relating to a particular aspect. For example, the data store illustrated includes mechanisms for storing information which may be used by modules described herein, such as inventory information 1012, route planning information 1014, and/or user information 1018. It should be understood that there may be many other aspects that may need to be stored in the data store, such as for page image information and to access right information, which may be stored in any of the above listed mechanisms as appropriate or in additional mechanisms in the data store 1010. The data store 1010 is operable, through logic associated therewith, to receive instructions from the application server 1008 and obtain, update or otherwise process data in response thereto.

Each server typically will include an operating system that provides executable program instructions for the general administration and operation of that server and typically will include a computer-readable storage medium (e.g., a hard disk, random access memory, read only memory, etc.) storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 10. Thus, the depiction of the system 1000 in FIG. 10 should be taken as being illustrative in nature and not limiting to the scope of the disclosure.

The various embodiments further may be implemented in a wide variety of operating environments, which in some cases may include one or more user computers, computing devices or processing devices which may be used to operate any of a number of applications. User or client devices may include any of a number of general purpose personal computers, such as desktop or laptop computers running a standard operating system, as well as cellular, wireless and handheld devices running mobile software and capable of supporting a number of networking and messaging protocols. Such a system also may include a number of workstations running any of a variety of commercially-available operating systems and other known applications for purposes such as development and database management. These devices also may include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”) and AppleTalk®. The network may be, for example, a local area network, a wide-area network, a virtual private network, the Internet, an intranet, an extranet, a public switched telephone network, an infrared network, a wireless network, and/or any combination thereof.

In embodiments utilizing a Web server, the Web server may run any of a variety of server or mid-tier applications, including Hypertext Transfer Protocol (“HTTP”) servers, FTP servers, Common Gateway Interface (“CGI”) servers, data servers, Java servers and business application servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python or TCL, as well as combinations thereof. The server(s) may also include database servers, including without limitation those commercially available from Oracle®, Microsoft®, Sybase®, and IBM®.

The environment may include a variety of data stores and other memory and storage media as discussed above. These may reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers or other network devices may be stored locally and/or remotely, as appropriate. Where a system includes computerized devices, each such device may include hardware elements that may be electrically coupled via a bus, the elements including, for example, at least one central processing unit (“CPU”), at least one input device (e.g., a mouse, keyboard, controller, touch screen or keypad) and at least one output device (e.g., a display device, printer or speaker). Such a system may also include one or more storage devices, such as disk drives, optical storage devices and solid-state storage devices such as random access memory (“RAM”) or read-only memory (“ROM”), as well as removable media devices, memory cards, flash cards, etc.

Such devices also may include a computer-readable storage media reader, a communications device (e.g., a modem, a network card (wireless or wired), an infrared communication device, etc.) and working memory as described above. The computer-readable storage media reader may be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and computer readable media for containing code, or portions of code, may include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which may be used to store the desired information and which may be accessed by the a system device. Based at least in part on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this disclosure are described herein, including the best mode known to the inventors for carrying out the invention. Variations of those preferred embodiments may become apparent to those of ordinary skill in the art upon reading the foregoing description. The inventors expect skilled artisans to employ such variations as appropriate and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications and patents, cited herein are hereby incorporated by reference to the same extent as if each reference were individually and specifically indicated to be incorporated by reference and were set forth in its entirety herein.

What is claimed is:

1. An inventory management system, comprising:
a material holder including a plurality of bins configured to store items;
a mobile drive unit configured to move the material holder;
a station configured for performance of a task related to one or more items and the material holder and associated bin based at least in part on the material holder being positioned at the station;
a first set of capacitive proximity sensors coupled with the material holder and configured to detect an interaction with the associated bins, each capacitive proximity sensor of the first set of capacitive proximity sensors defining a respective first line arranged horizontally with respect to the material holder;
a second set of capacitive proximity sensors coupled with the material holder and configured to detect the interaction with the associated bins, each capacitive proximity sensor of the second set of capacitive proximity sensors defining a respective second line arranged vertically with respect to the material holder; and
a management module communicatively coupled with the mobile drive unit, the first set of capacitive proximity sensors, and the second set of capacitive proximity sensors and configured to:
receive first signals from a first pair of capacitive proximity sensors of the first set of capacitive proximity sensors indicating interaction by an item with the associated bins of the material holder;
receive second signals from a second pair of capacitive proximity sensors of the second set of capacitive proximity sensors indicating the interaction by the item with the associated bins of the material holder;
determine a location of the interaction based at least in part on the first signal and the second signal;
identify a particular bin of the associated bins for the material holder to associate with the location of the interaction based at least in part on inventory holder information associated with the inventory management system; and
update the inventory holder information associated with the inventory management system to associate the item with particular bin and the corresponding material holder based at least in part on determining the location of the interaction.

2. The inventory management system of claim 1, wherein the first signals and the second signals include a strength of signals provided by the first pair of capacitive proximity sensors of the first set of capacitive proximity sensors with respect to the first lines and the second pair of capacitive proximity sensors of the second set of capacitive proximity sensors with respect to the second lines.

3. The inventory management system of claim 2, wherein determining the location of the interaction is further based at least in part on an algorithm that selects the particular bin that is closest proximally to a first location along the first lines and closest proximally to a second location along the second lines based at least in part on the strength of signals provided by the first pair of capacitive proximity sensors of the first set of capacitive proximity sensors with respect to the first lines and the second pair of capacitive proximity sensor of the second set of capacitive proximity sensors with respect to the second lines.

4. The inventory management system of claim 1, wherein the first set of capacitive proximity sensors and the second set of capacitive proximity sensors are bodily incorporated into the material holder with respect to the first lines and the second lines.

5. A computer-implemented method, comprising:
maintaining, by a computer system, material holder information associated with a material holder, the material holder configured to store items in associated bins, a bin of the bins comprising one or more proximity sensors coupled with one or more walls of the bin and configured to detect interaction by an item of the items;
receiving, by the computer system, signal information from the one or more proximity sensors associated with a portion of the bins in response to an interaction by the item with the inventory holder, the signal information identifying a respective strength of signals provided by each proximity sensor of the one or more proximity sensors from a corresponding bin of the portion of the bins;
identifying, by the computer system, a location of the interaction with which to associate to a particular bin of the portion of bins in the material holder based at least in part on an algorithm that utilizes the signal information to identify a strongest signal provided by the one or more proximity sensors of the portion of the bins of the material holder in comparison to the strength of the signals provided by the one or more proximity sensors of other bins of the material holder; and
updating, by the computer system, the material holder information to associate the item with the particular bin in the material holder in response to identifying the location of the interaction.

6. The computer-implemented method of claim 5, wherein the one or more proximity sensors include at least one of a near field communication (NFC) sensor, a radio frequency identification (RFID) sensor, an inductive proximity sensor, or a capacitive proximity sensor.

7. The computer-implemented method of claim 5, wherein receiving the signal information from the one or more proximity sensors associated with the portion of the bins is in response to an entity interacting with the portion of the bins and utilizing a wearable device.

8. The computer-implemented method of claim 7, wherein receiving the signal information from the one or more proximity sensors associated with the portion of the bins is based at least in part on a transmitter of the wearable device interacting with a receiver of the one or more proximity sensors.

9. The computer-implemented method of claim 5, further comprising updating the material holder information to disassociate the item with the particular bin in the material holder in response to receiving updated signal information from the one or more proximity sensors of the portion of bins.

10. The computer-implemented method of claim 5, wherein the material holder further comprises one or more facings, each facing enabling access to a subset of corresponding bins of the material holder.

11. The computer-implemented method of claim 10, further comprising activating, by the computer system, the one or more proximity sensors associated with the subset of the corresponding bins based at least in part on information identifying a particular facing of the one or more facings of the material holder being interacted with by an entity.

12. A material holder, comprising:
bins configured to store items;
one or more proximity sensors coupled with the material holder and configured to detect interaction with the bins; and
a management module coupled with the material holder and communicatively coupled with the one or more proximity sensors and configured to:
maintain material holder information that identifies locations of the items in associated bins of the material holder;
obtain signal information from the one or more proximity sensors in response to an interaction with the material holder, the signal information identifying a range of signal strengths provided by the one or more proximity sensors that correspond to locations of the one or more proximity sensors with respect to the material holder; and
determine a location of the interaction with which to associate to a particular bin of the bins of the material holder based at least in part on the signal information.

13. The inventory holder of claim 12, wherein the management module is further configured to instruct an entity, via an associated user interface, to replace a particular proximity sensor of the one or more proximity sensors based at least in part on the signal information.

14. The inventory holder of claim 12, wherein the management module is further configured to update the material holder information to identify that a particular item is stored in the particular bin of the material holder in response to determining the location of the interaction.

15. The inventory holder of claim 12, wherein the management module is further configured to maintain one or more threshold values associated with signals provided by the one or more proximity sensors in response to interactions with the material holder.

16. The inventory holder of claim 15, wherein determining the location of the interaction is further based at least in part on comparing the signal information to the one or more threshold values.

17. The inventory holder of claim 12, wherein the bins are comprised of non-rigid materials so as to flex in response to receiving the items.

18. The inventory holder of claim 12, wherein the one or more proximity sensors are comprised of non-rigid materials so as to flex in response to receiving the items.

19. The inventory holder of claim 12, wherein the management module is further configured to receive a request, from an entity, to access the material holder, the material holder further comprising one or more facings, each facing of the one or more facings including a subset of proximity sensors of the one or more proximity sensors.

20. The inventory holder of claim 19, wherein the management module is further configured to activate the subset of proximity sensors for a facing of the one or more facings of the material holder in response to receiving the request from the entity to access the material holder.
